(19) United States
(12) Patent Application Publication
(10) Pub. No.: US 2008/0115778 A1
(43) Pub. Date: May 22, 2008

(54) GRATE APPARATUS AND METHOD

(76) Inventor: Paul Bryan Cadima, Prospect, KY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/562,555

(22) Filed: Nov. 22, 2006

(51) Int. Cl. F23H 13/00; F23H 17/00; B23P 17/00

(52) U.S. Cl. 126/152 B; 126/152 R; 29/592

(57) ABSTRACT

A grate apparatus configured to support a cooking utensil on a range stove. The grate apparatus includes a base portion configured to be disposed on the range stove. An intermediate portion extends from the base portion. A utensil supporting portion is connected to the base portion through the intermediate portion. The supporting portion includes a top surface configured to face and be disposed opposite the cooking utensil. The top surface includes a plurality of protrusions configured to support the cooking utensil.

### BACKGROUND OF THE INVENTION

The described technology relates to a grate apparatus, such as for a range stove or oven, and a corresponding method.

It is known to use a grate on a range, such that a cooking utensil is spaced apart form a heat source used to heat the cooking utensil. Such a heat source includes a frame produced by the combustion of natural gas or propane.

It is also known to form the grate from cast iron, and to coat the grate with porcelain enamel. The coated grate is easier to clean and has a more attractive appearance as compared to an uncoated grate. However, the porcelain enamel coating is susceptible to discoloration and staining, especially when subjected to high temperatures from the heat source. Thus, the aesthetic quality of the porcelain enamel coated grate is negated.

Therefore, it may be desirable to coat the grate with a material resistant to discoloration and staining, such as a non-stick coating. However, a grate coated with any of a number of known non-stick coatings also suffers from numerous disadvantages. These non-stick coatings cannot withstand the severe abrasion resulting from movement of the cooking utensil on the grate. As a result, the non-stick coatings were away, such that an uncoated portion of the grate is partially visible. Thus, as with the porcelain enamel coated grate, the aesthetic quality of the non-stick coated grate is negated. Further, the non-stick coatings do not provide enough friction between the cooking utensil and the grate, resulting in instability of the cooking utensil on the grate.

### BRIEF DESCRIPTION OF THE INVENTION

As described herein, embodiments of the invention overcome one or more of the above or other disadvantages known in the art.

In an embodiment, a grate apparatus is configured to support a cooking utensil on a range stove. The grate apparatus includes a base portion configured to be disposed on the range stove. An intermediate portion extends from the base portion. A utensil supporting portion is connected to the base portion through the intermediate portion. The supporting portion includes a top surface configured to face and be disposed opposite the cooking utensil. The top surface includes a plurality of protrusions configured to support the cooking utensil.

Another embodiment is directed to a method of forming a grating for a range stove. The method includes providing a grate with a base portion configured to be disposed on the range stove, an intermediate portion extending from the base portion, and a utensil supporting portion connected to the base portion through the intermediate portion. The supporting portion includes a top surface configured to face and be disposed opposite a cooking utensil. A plurality or protrusions is formed on the top surface. The plurality of protrusions is configured to support the cooking utensil.

### BRIEF DESCRIPTION OF THE DRAWINGS

The following figures illustrate examples of embodiments of the invention. The figures are described in detail below.

FIG. 1 is a top isometric view of an embodiment of a grate apparatus.

FIG. 2 is a side view of the grate apparatus of FIG. 1.

FIG. 3 is a detail view of a portion of the grate apparatus of FIG. 1.

### DETAILED DESCRIPTION OF EMBODIMENTS OF THE INVENTION

Embodiments of the invention are described below, with reference to the figures. Throughout the figures, like reference numbers indicate the same or similar components.

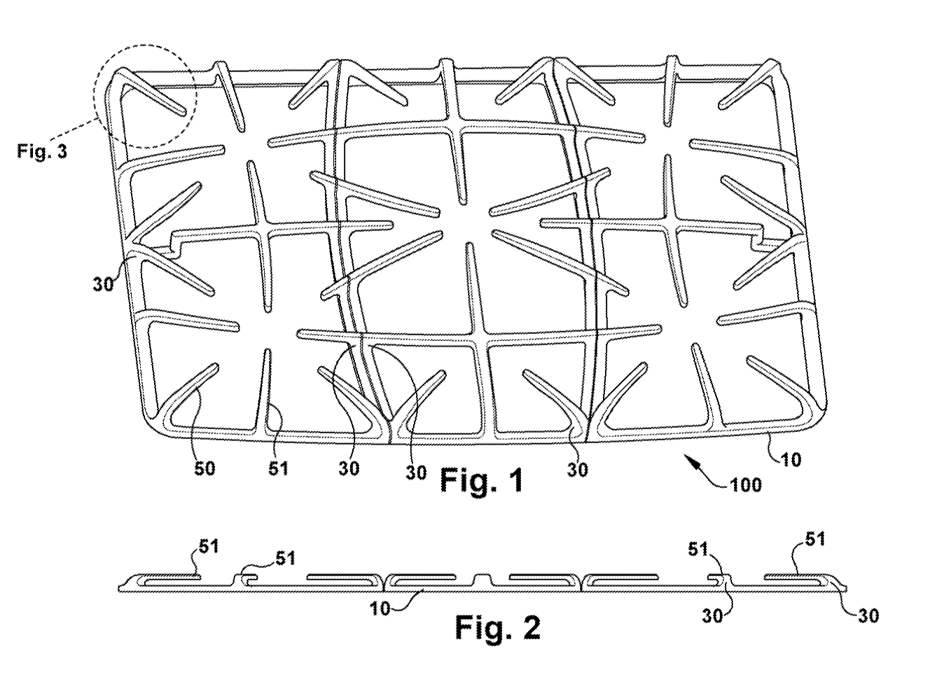

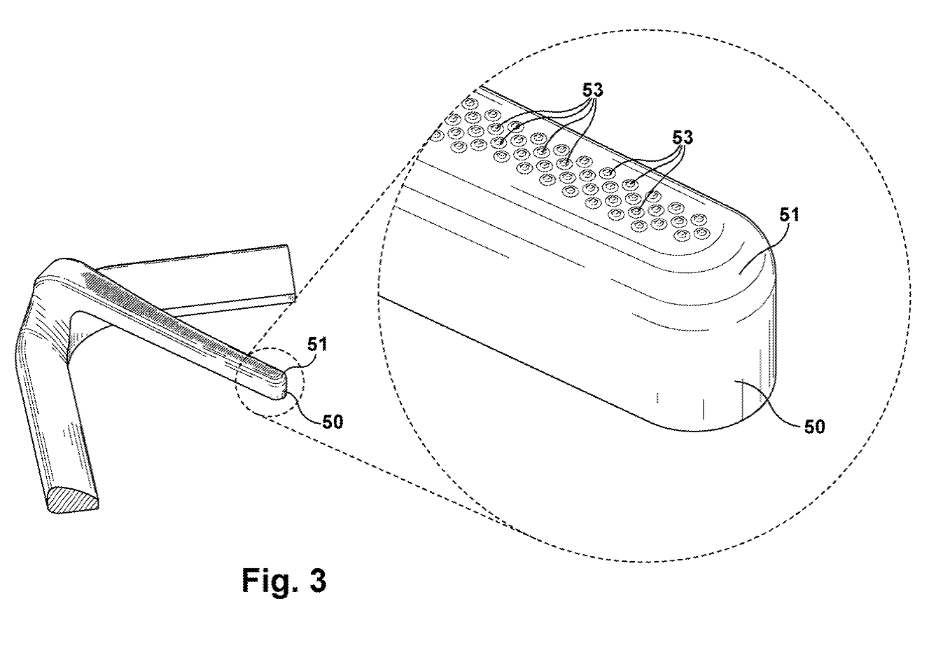

FIG. 1 is a top isometric view of an embodiment of a grate apparatus. FIG. 2 is a side view of the grate apparatus, and FIG. 3 is a detail view of a portion of the grate apparatus. As shown in the drawings, the grate apparatus 100 includes a base portion 10. The base portion 10 is configured to support the grate apparatus 100 on a range stove (such as a range cook top), whether the range stove is separate from or part of an oven, and whether the range stove has one or more heat sources (e.g., burners). Although the drawings show specific embodiments of the base portion 10, the base portion 10 can include additional or different components, as long as the base portion 10 can support the grate apparatus 100 on the range stove.

The grate apparatus 100 also includes a plurality of each of utensil supporting portions 50 and intermediate portions 30. The intermediate portions 30 connect the utensil supporting portions 50 with the base portion 10. The intermediate portions 30 can extend about perpendicular to a plane defined by the base portion 10, and can extend about perpendicular to a plane defined by a top surface of the range stove on which the base portion 10 is disposed and/or contacts. Although the drawings show specific embodiments of the intermediate portions 30, the intermediate portions 30 can include additional or different components, as long as the intermediate portions 30 connect the utensil supporting portions 50 with the base portion 10.

The utensil supporting portions 50 are configured to support a cooking utensil, such as a port, pan, and/or other cookware, on top surfaces 51 thereof. The utensil supporting portions 50 can extend about perpendicular to the intermediate portions 30, and can extend and/or be disposed in a plane that is about parallel to a plane defined by the top surface of the range stove on which the base portion 10 is disposed and/or contacts, and/or be disposed in a plane that is about parallel to the plane defined by the base portion 10. The utensil supporting portions 50 may extend like fingers from an outer perimeter toward a center of a heating source disposed through and/or on the top surface of the range stove, the heating source configured to heat the cooking utensil supported by the utensil supporting portions 50.

The top surfaces 51 are configured to face, be disposed near, and be disposed opposite a bottom surface of the cooking utensil supported by the utensil supporting portions 50. Although omitted from FIGS. 1 and 2 for purposes of clarity, as shown in FIG. 3 the top surfaces 51 include a plurality of protrusions 53 extending therefrom. By this arrangement, the cooking utensil supported on the grate apparatus 100 is in actuality supported by the protrusions 53 on the top surface 51 of the utensil supporting portions 50. The top surface 51 can be disposed partially or completely in a plane, such that the top surfaces are about completely flat, or are curved with about flat portions. In an embodiment of the invention, the cooking utensil is only supported by the protrusions 53, and is not otherwise supported by the top surfaces 51 of the utensil supporting portions 50.

The above-discussed arrangement provides numerous advantages over known coated grates. Specifically, the grate apparatus 100 can be coated with any of numerous non-stick coatings, and can avoid one or more of the above-discussed or other disadvantages of the known grate coated with a non-stick coating or a porcelain enamel coating.

In particular, wearing away of the non-stick coating on the top surfaces 51 of the utensil supporting portions 50 of the grate apparatus 100 is avoided, as the top surface 51 does not contact the cooking utensil disposed on the grate apparatus 100. Rather, as discussed, the cooking utensil is supported by an contacts the protrusions 53. Thus, in the event that the protrusions 53 are initially provided with a non-stick coating, and the coating wears off the protrusions 53 as a result of contact with the cooking utensil disposed thereon, the wear would be barely noticeable, and may not be noticeable at all depending on the color of the underlying grate and the color of the non-stick coating. For example, the underlying cast iron grate may be black in color, and the non-stick coating may also be black in color. Further, because the wear of the non-stick coating occurs only on the protrusions 53, the extent to which the non-stick coating wears is limited or controlled. Thus, the grate apparatus 100 would maintain an attractive appearance, appearing to include textured portions on the top surfaces 51.

Additionally, because the cooking utensil would be supported by the protrusions 53, the grate apparatus 100 would provide increased friction between itself and the cooking utensil disposed thereon as compared to the known grate coated with the non-stick coating which does not include any protrusions 53. Still further, cleaning of the grate apparatus 100 would be facilitated because of the use of the non-stick coating, which resists discoloration and staining at high temperatures to a greater extent than the known porcelain enamel coating.

It is to be understood that features of the invention are related to the use of the protrusions 53 on the top surfaces 51, the use of the protrusions 53 to support the cooking utensil, and/or the use of the non-stick coating on the top surfaces 51 that include the protrusions 53. Other described components may or may not be present in the grate apparatus 100.

In the described embodiments, the grate apparatus 100 is coated with a non-stick coating. Any one or more suitable non-stick coating can be used, such as an enamel non-stick coating. One such known enamel non-stick coating is REAL-EASE, manufactured by Ferro Corporation. One or more portions of the grate apparatus 100 can be coated with the non-stick coating, including any or all of the base portion 10, one or more of the intermediate portions 30, one or more of the utensil supporting portions 50, one or more of the top surfaces 51, and/or one or more of the protrusions 53. In an embodiment of the invention, the entirety of the grate apparatus 100 can be coated with the non-stick coating. Coating can be accomplished by spraying, dipping or other processes that result in the coating covering all or a portion of the grate apparatus 100. In embodiments of the invention, the grate apparatus 100 is immersed in the coating, or the grate apparatus 100 is sprayed with the coating.

As discussed, the protrusions 53 can initially be coated with the non-stick coating. At the time of manufacture, some or all of the non-stick coating can be removed from one or more of the protrusions 53 (such as through an abrasive operation), and/or some or all of the non-stick coating can be removed from one or more of the protrusions 53 through use of the grate apparatus 100 on the range stove (e.g., through placement and removal of the cooking utensil on the grate apparatus 100).

It is further to be understood that the arrangement, size, and/or number of protrusions 53 can be determined to achieve one or more desired results (e.g., control of friction between the cooking utensil and the grate apparatus 100, ease of cleaning the top surfaces 51, appearance of the top surfaces 51, etc.). For example, heights of the protrusions 53, as well as number or placement of the protrusions 53, can be determined such that the cooking utensil is supported only by the protrusions 53 and not otherwise supported by any of the top surface 51. Although the figures show embodiments of the invention in which each of the top surfaces 51 includes a plurality of protrusions 53, the protrusions 53 need not be placed on each top surface 51, and a plurality of protrusions 53 need not be placed on the top surfaces 51. For example, some number of the top surfaces 51 can each include at least one protrusion 53, each of the top surfaces 51 can include at least one protrusion 53, or each of the top surfaces 51 can include a plurality of protrusions 53. It is contemplated that the protrusions 53 and the non-stick coating can be used with a cast iron grate (iron base portions 10, intermediate portions 30 and utensil supporting portions 50 cast as a single, unitary, piece). However, the base portion 10, intermediate portions 30, and/or utensil supporting portions 50 are not limited to cast iron, are not limited to being cast, and are not limited to being manufactured in a single casting, forming, machining or other manufacturing operation.

It is to be understood that the protrusions 53 are not limited to the illustrated shape and/or arrangement. It is contemplated that in embodiments of the invention, the protrusions 53 are disposed in non-linear arrays, and/or have non-circular shapes. For example, the protrusions 53 can include raised lines or arcs, which can be concentric with one another. It is further contemplated that in embodiments of the invention, a spacing between protrusions 53, and/or a height of the protrusions 53, are determined to prevent pooling of the non-stick coating between the protrusions 53, and/or based on aesthetics of the grate apparatus 100. When a thickness of the non-stick coating is about 0.011 inches (0.028 cm), a minimum height of the protrusions 53 can be about 0.020 inches (0.051 cm).

It is to be understood that although embodiments of the invention are described with respect to the non-stick coating for the grate apparatus 100, embodiments of the invention encompass the use of a different coating on the grate apparatus 100. By way of specific, non-limiting examples, a stain resistant coating and/or a discoloration resistant coating can be used in place of or in addition to the non-stick coating. In embodiments of the invention, the coating one or more of (i) resists high temperatures, such as in excess of about 1200 degrees Fahrenheit (650 degrees Celsius), (ii) resist damage caused by movement of the cooking utensil, such as a cast iron utensil, on the grate apparatus 100, and/or (iii) provide non-stick, strain resistant and/or discoloration resistant properties.

Further, one or more of any or all of these coatings can be used with the grate apparatus 100 that includes a known coating, such as a known porcelain enamel coating. One or more portions of the grate apparatus 100 can be coated with the known porcelain enamel coating, including any or all of the base portion 10, one or more of the intermediate portions 30, one or more of the utensil supporting portions 50, one or more of the top surfaces 51, and/or one or more of the protrusions 53. In an embodiment of the invention, the entirety of the grate apparatus 100 can be coated with the known porcelain enamel coating. Coating can be accomplished by spraying, dipping or other processes that result in the known porcelain enamel coating covering all or a portion of the grate apparatus 100. In embodiments of the invention, the grate apparatus 100 is immersed in the known porcelain enamel coating, or the grate apparatus 100 is sprayed with the known porcelain enamel coating. The non-stick, stain resistant and/or discoloration resistant coating can be coated or the known porcelain enamel coating, on the grate apparatus 100. For example, the known porcelain enamel coating can be disposed directly on the top surfaces 51, and the non-stick, stain resistant and/or discoloration resistant coating can be disposed directly on the known porcelain enamel coating.

It is to be understood that although embodiments of the invention are described with respect to the known porcelain enamel coating, embodiments of the invention encompass the use of a different known coating on the grate apparatus 100. By way of specific, non-limiting example, a known ceramic enamel or glass enamel coating can be disposed on the grate apparatus 100 under the non-stick, stain resistant and/or discoloration resistant coating.

The written description uses examples to disclose embodiments of the invention, including the best mode, and also to enable a person or ordinary skill in the art to make and use embodiments of the invention. It is understood that the patentable scope of embodiments of the invention is defined by the claims, and can include additional components occurring to those skilled in the art. Such other arrangements are understood to be within the scope of the claims.

1. A grate apparatus configured to support a cooking utensil on a range stove, the grate apparatus comprising:
a base portion configured to be disposed on the range stove;
an intermediate portion extending from the base portion; and
a utensil supporting portion connected to the base portion through the intermediate portion, the supporting portion comprising a top surface configured to face and be disposed opposite the cooking utensil, the top surface comprising a plurality of protrusions, the plurality of protrusions configured to support the cooking utensil thereon.

2. The grate apparatus of claim 1, comprising a plurality of utensil supporting portions, at least one of the utensil supporting portions comprising the top surface including the plurality of protrusions.

3. The grate apparatus of claim 1, comprising a plurality of utensil supporting portions, each of the plurality of utensil supporting portions comprising top surfaces, and each of the top surfaces comprising a plurality of protrusions.

4. The grate apparatus of claim 1, further comprising a coating disposed on the base portion, the intermediate portion, and the utensil supporting portion.

5. The grate apparatus of claim 1, further comprising a coating disposed on the top surface of the utensil supporting portion.

6. The grate apparatus of claim 1, further comprising coating disposed on the utensil supporting portion exclusive of the plurality of protrusions.

7. The grate apparatus of claim 1, comprising an enamel coating disposed on the utensil supporting portion.

8. The grate apparatus of claim 7, comprising a second coating disposed on the enamel coating and on the top surface of the utensil supporting portion exclusive of the plurality of protrusions.

9. The grate apparatus of claim 1, comprising a plurality of utensil supporting portions disposed in a plane about parallel to a plane defined by the base portion, each of the plurality of utensil supporting portions comprising top surfaces and a plurality of protrusions extending form the top surfaces, the plurality of protrusions having a height sufficient to support thereon the cooking utensil such that the cooking utensil does not contact the top surfaces.

10. A method of forming a grating for a range stove, comprising:
providing a grate including a base portion configured to be disposed on the range stove, an intermediate portion extending from the base portion, and a utensil supporting portion connected to the base portion through the intermediate portion, the supporting portion comprising a top surface configured to face and be disposed opposite a cooking utensil; and
forming a plurality of protrusions on the top surface, the plurality of protrusions configured to support the cooking utensil.

11. The method of claim 10, wherein providing the grate comprises casting the base portion, the intermediate portion and the utensil supporting portion.

12. The method of claim 10, further comprising:
providing a coating on at least the top surface of the utensil supporting portion.

13. The method of claim 10, further comprising:
providing a coating on at least the utensil supporting portion.

14. The method of claim 13, further comprising:
removing the coating from each of the plurality of protrusions of the utensil supporting portion.

15. The method of claim 13, further comprising:
removing the coating from each of the plurality of protrusions of the utensil supporting portion by an abrasive operation.

16. The method of claim 10, wherein providing the grate comprises providing a plurality of utensil supporting portions connected to the base portion through a plurality of intermediate portions, the supporting portions disposed in a plane about parallel to a plane in which the base portion is disposed, each of the supporting portions comprising top surfaces, and each of the top surfaces comprising a plurality of protrusions.

17. The method of claim 16, further comprising:
providing a coating on the top surfaces of the plurality of supporting portions.

18. The method of claim 16, further comprising:
providing an enamel coating on the plurality of supporting portions.

19. The method of claim 18, further comprising:
providing a second coating on the enamel coating and on the top surfaces of the plurality of supporting portions; and
removing the second coating from the plurality of protrusions.

20. The method of claim 19, wherein removing comprises removing by an abrasive operation.
